(19) United States
(12) Patent Application Publication
(10) Pub. No.: US 2012/0034577 A1
(43) Pub. Date: Feb. 9, 2012

(54) DENTAL IMPLANT WITH OSTEOINDUCTIVE CARRIER SYSTEM

(76) Inventor: Edgard El Chaar, New York, NY (US)

(21) Appl. No.: 13/198,353

(22) Filed: Aug. 4, 2011

Related U.S. Application Data
(60) Provisional application No. 61/370,703, filed on Aug. 4, 2010.

(51) Int. Cl. A61C 8/00

(52) U.S. Cl. 433/174

(57) ABSTRACT

A dental implant has a first coronal portion having a first width and a second apical portion having a second smaller width, where a taper between the coronal and the apical portions is of constant slope. A threaded arrangement on an outer surface of the dental implant is provided with an osteoinductive growth stimulating substance located on the outer surface of the dental implant.

### RELATED APPLICATION

This application claims the benefit of priority from U.S. Provisional Patent Application No. 61/370,703, filed on Aug. 4, 2010, the entirety of which is incorporated by reference.

### BACKGROUND

1. Field of the Invention

The present arrangement relates to a dental surgery device and method for implementing the same.

2. Description of the Related Art

The process known as osseointegration is the process where an implant, placed into bone, is integrated over time as a stable implant within the bone structure.

Generally speaking osseointegration has both a mechanical stability component and a biological stability component that together form the overall stability of the implant. Mechanical stability refers to the physical integration/interface stability between the outer surfaces of the implant and the bone into which it is inserted. From the implant side, mechanical stability is influenced by many factors, including the shape of implant, the shape of the threading on the implant if any, the material of the implant, the surface characteristics (smoothness/roughness), etc.

Biological stability refers to the actual integration process between the implant and the bone into which it is inserted. The biological stability is also influenced by many different factors, many of which are based on the patient's rate of healing, but it is also influenced by characteristics of the mating surfaces between the bone and the implant.

In the area of dental implants there is a challenge for continual improvement. The mouth area and associated bone provide unique challenges to perfect osseointegration of dental implants.

### OBJECTS AND SUMMARY

In accordance with various embodiments, a dental implant s provided that has a self tap smooth-constant slope tapered arrangement.

In one aspect of the arrangement, the thread pattern on the implant remains the same from its apical portion to its coronal portion.

In another aspect of the arrangement, an osteoinductive growth stimulating substance such as Bone Morphogenetic Protein (BMP-2) or GDF-5 (Growth/Differentiation Factor protein) is provided using at least two different delivery methods. A first method includes the step of immersing the implant in a vial containing an activated growth stimulating substance and delivering the immersed implant for its final use. The second method includes the step of immersing the implant in the vial during the actual implant surgery for time period, such as 15-20 minutes.

To this end the present arrangement provides a dental implant having a first coronal portion having a first width and a second apical portion having a second smaller width, where a taper between the coronal and the apical portions is of constant slope. A threaded arrangement on an outer surface of the dental implant is provided with an osteoinductive growth stimulating substance located on the outer surface of the dental implant.

### BRIEF DESCRIPTION OF THE DRAWINGS:

The present invention can be best understood through the following description and accompanying drawings, wherein:

FIGS. 1A-1C show three arrangements for a dental implant according to one embodiment;

FIG. 2 shows a dental implant from FIGS. 1A-1C submersed in osteoinductive growth stimulating substance;

FIG. 3 is a flow chart for a dental implant surgery according to one embodiment; and

FIG. 4 is a flow chart for a dental implant surgery according to another embodiment.

### DETAILED DESCRIPTION

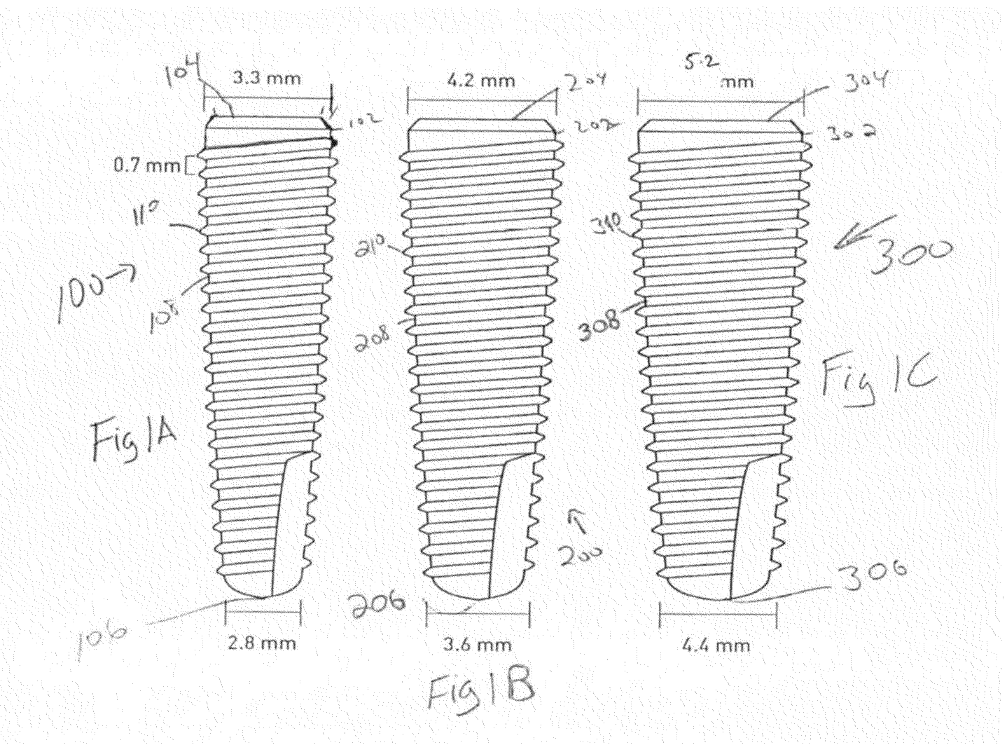

In accordance with one embodiment, as shown in FIGS. 1A-1C three dental implants 100, 200 and 300 having a smooth taper are provided. Implants may be constructed of typical metals used for implants, such as titanium, or other composite/alloy/artificial materials used in other bone implants. For the purposes of illustrating the salient features, implants 100, 200 and 300 are considered to be constructed of titanium for the below described arrangements.

In the first arrangement shown in FIG. 1A, implant 100 shows a self tap and smooth tapered implant exhibiting a width of 3.3 mm at an upper neck region 102, at its coronal portion, with sharply tapered upper table region 104 which may have various accommodations for accepting denture or tooth components (not shown). From the 3.3 mm width at the coronal neck region 102, implant 100 tapers down—at a constant slope towards its apical portion 106 to a width of 2.8 mm.

In another arrangement shown in FIG. 1B, implant 200 is similarly shaped to implant 100, but exhibits a width of 4.2 mm at an upper neck region 202, at its coronal portion, with sharply tapered upper table region 204. From the 4.2 mm width at the coronal neck region 202, implant 200 tapers down towards its apical portion 206 to a width of 3.6 mm.

In another arrangement shown in FIG. 1C, implant 300 is similarly shaped to implants 100 and 200, but exhibits a width of 5.2 mm at an upper neck region 302, at its coronal portion, with sharply tapered upper table region 304. From the 5.2 mm width at the coronal neck region 302, implant 200 tapers down towards its apical portion 306 to a width of 4.4 mm.

It is understood that the above three arrangements from FIGS. 1A-1C are exemplary implants that may be employed most commonly for various dent& implant uses, however, the invention is not limited in scope to these dimensions and other desired dimensions may be provided for corresponding dental applications.

As shown in each of FIGS. 1A-1C, each of implants 100, 200 and 300 employ threads 110, 210 and 310 respectively, that extend continuously with the same pattern from the apical portions 106, 206 and 306 all the way to their coronal portions at the neck 102, 202 and 302. In the present arrangement, threads 110, 210 and 310 are distanced at 0.7 mm apart (as measured from adjacent thread apexes).

According to the above arrangements, implants 100, 200 and 300 exhibit an increase in primary (mechanical) stability with an enhanced locking effect in both healed sites and in the immediate implant placement with immediate or delayed load, such as that provided by an embedded prosthetic crown,

In accordance with another embodiment of the invention, Implants 100, 200 and 300 each maintain a surface texture 108, 208 and 308 respectively, that improves osseointegration and healing times. In one arrangement, surface textures 108, 208 and 308 include hydrophilic surfaces. In another arrangement, surface textures 108, 208 and 308 may be roughened textures that allow bone formation more easily. For example, microstructuring surfaces 108, 208 and 308 of implants 100, 200 and 300 by sandblasting and add etching enhances the bone formation along the titanium surface. For example, surfaces 108, 208 and 308 may be imparted by a soluble blasted media (SBM) surface texture treatment, such as an SBM containing soluble hydroxyl apatite (HA) particles.

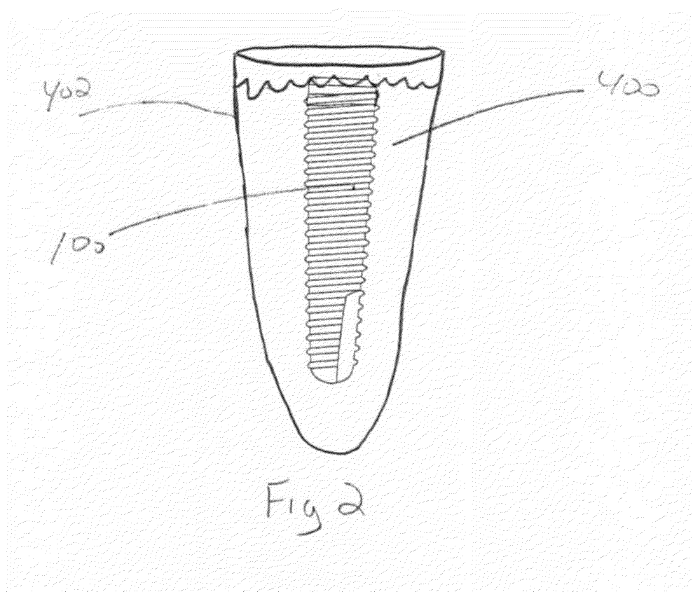

In another embodiment, Implants 100, 200 or 300 may be Implemented in conjunction with the use of an osteoinductive growth stimulating substance. As shown in FIG. 2, an osteoinductive growth stimulating substance 400 is placed in a vial 402 and an implant, such as implant 100 is placed therein, prior to being implanted in the desired location in the patient's bone.

In a first arrangement, rh-BMP-2 (Bone Morphogenetic Protein) is used as osteoinductive growth stimulating substance 400. In a second arrangement, GDF-5 (Growth/Differentiation Factor protein) is used as the osteoinductive growth stimulating substance 400. Although these two osteoinductive growth stimulating substances 400 are discussed, the invention is not limited in this respect and other bone growth factors may be used. By placing implant 100 in an immersion of growth stimulating substance 400 the rh-BMP2 or GDF-5 accumulates on the roughened surfaces 108 of dental implant 100.

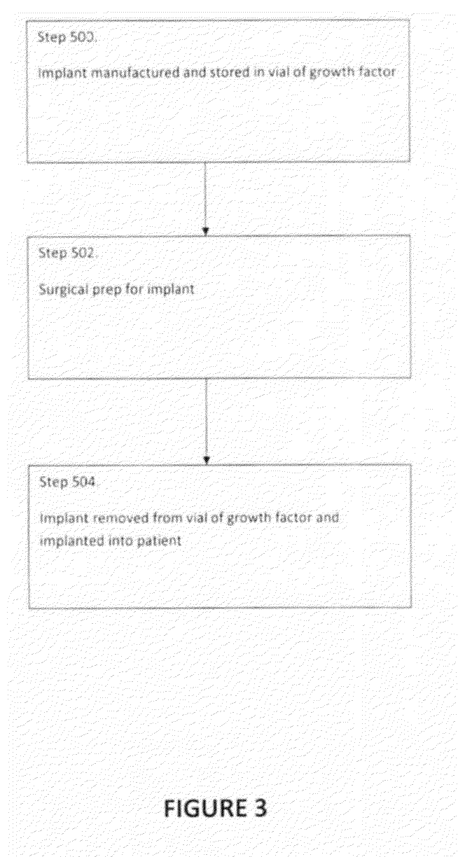

Turning to an implant procedure, as illustrated in FIG. 3, at a first step 500 after implant 100 is manufactured, it is stored in a vial 402 of osteoinductive growth stimulating substance 400. At step 502 a surgeon or dentist prepares the implant site according to normal procedures. At step 504, the implant is removed and inserted according to normal implant procedures.

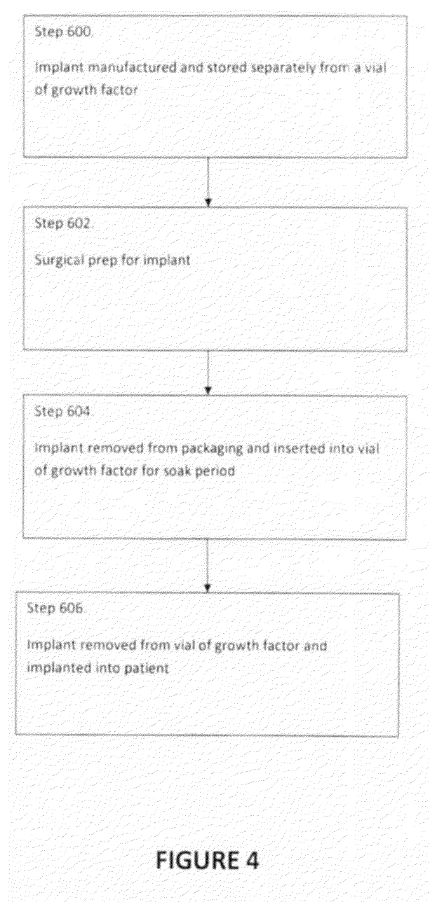

In an alternative embodiment, as illustrated in FIG. 4, implant 100 and vial 402 of osteoinductive growth stimulating substance 400 are packaged separately at a first step 600. At step 602 a surgeon or dentist prepares the implant site according to normal procedures. At step 604, possibly concurrently with the site preparation, implant 100 is placed into vial 402 of osteoinductive growth stimulating substance 400. This soak in growth stimulating substance 400 may be carried out for 15-20 minutes. Finally, after the soak, implant 100 with growth stimulating substance 400 adhered thereto is inserted according to normal implant procedures at step 606.

In either of the above procedures, the bone growth factor 400 is deposited on the roughened implant surface 108 so as to improve osseointegration and reduce the healing time period.

While only certain features of the invention have been illustrated and described herein, many modifications, substitutions, changes or equivalents will now occur to those skilled in the art, It is therefore, to be understood that this application is intended to cover all such modifications and changes that fall within the true spirit of the invention.

What is claimed is:

1. A dental implant, said dental implant comprising:
a first coronal portion having a first width;
a second apical portion having a second smaller width, where a taper between said coronal and said apical portions is of constant slope;
a threaded arrangement on an outer surface of said dental implant; and
an osteoinductive growth stimulating substance located on the outer surface of said dental implant.

2. The dental implant of claim 1, where said first coronal portion further maintains a sharply tapered upper table region configured to accommodate denture or tooth components.

3. The dental implant of claim 1, wherein said threaded arrangement has a constant distance between the threading measured between adjacent apexes,

4. The dental implant of claim 3, wherein said constant distance is substantially 0.7 mm.

5. The dental implant of claim 1, wherein said outer surface of said dental implant includes a roughened surface.

6. The dental implant of claim 5, wherein said roughened surface is a hydrophilic surface.

7. The dental implant of claim 5, herein said roughened surface is formed by sandblasting.

8. The dental implant of claim 7, wherein said roughened surface is formed by sandblasting using a soluble blasted media (SBM) containing soluble hydroxyl apatite (HA) particles.

9. The dental implant of claim 5, wherein said roughened surface is formed by add etching.

10. The dental implant of claim 5, wherein said roughened surface is formed by add etching,

11. The dental implant of claim 1, wherein said osteoinductive growth stimulating substance is rh-BMP-2 (Bone Morphogenetic Protein).

12. The dental implant of claim 1, wherein said osteoinductive growth stimulating substance is GDF-5 (Growth/Differentiation Factor protein).

13. The dental implant of claim 1, wherein said implant is made of titanium,

14. A dental surgery method, said method comprising:
obtaining a dental implant, with said dental implant having
a first coronal portion having a first width;
a second apical portion having a second smaller width, where a taper between said coronal and said apical portions is of constant slope;
a threaded arrangement on an outer surface of said dental implant;
applying an osteoinductive growth stimulating substance on said outer surface of said dental implant.

15. The method as claimed in claim 14, wherein said step of applying an osteoinductive growth stimulating substance on said outer surface of said dental implant involved packaging said implant.

16. The method as claimed in claim 14, wherein said step of applying an osteoinductive growth stimulating substance on said outer surface of said dental implant involved soaking said implant in a vial of said osteoinductive growth stimulating substance.

17. The method as claimed in claim 16, wherein said step of soaking said implant in a vial of said osteoinductive growth stimulating substance is conducted for substantially 15-20 minutes.
